(19) United States
(12) Patent Application Publication
(10) Pub. No.: US 2007/0029868 A1
(43) Pub. Date: Feb. 8, 2007

(54) Wheel rim for cycling device

(76) Inventor: Lai Chien Chen, Changchun Tsun (TW)

Correspondence Address: CHARLES E. BAXLEY, ESQ., 90 JOHN STREET, THIRD FLOOR, NEW YORK, NY, 10038, US

(21) Appl. No.: 11/290,324

(22) Filed: Nov. 29, 2005

(30) Foreign Application Priority Data
Aug. 8, 2005 (TW) 094213520

(51) Int. Cl. B60B 21/00

(52) U.S. Cl. 301/95.102; 301/95.104

(57) ABSTRACT

A wheel rim includes an outer rim member having a serrated surface formed in each of two side portions and defined by one or more recesses and one or more bulges, an inner rim member for attaching to an inner peripheral portion of the outer rim member and having two peripheral flanges for engaging with and for securing to the side portions of the outer rim member with an adhesive material. The inner rim member is preferably made of synthetic materials, and the outer rim member is preferably made of metal materials. The outer rim member includes a peripheral shoulder formed in each of the side portions for engaging with and for anchoring the peripheral flanges of the inner rim member.

### BACKGROUND OF THE INVENTION

1. Field of the Invention

The present invention relates to a wheel rim, and more particularly to a wheel rim for various cycling devices, such as unicycles, bicycles, tricycles, cycling exercises, etc., and having an attached inner peripheral member for weight reducing purposes and/or for decorative purposes.

2. Description of the Prior Art

Typical wheel rims for cycling devices, such as unicycles, bicycles, tricycles, cycling exercises, etc. comprise an outer peripheral recess formed therein for receiving or attaching a rubber tire thereon, and the wheel rims are typically made of metal materials which includes a great weight and which may greatly increase the weight to the cycling devices. However, for many of the cycling devices, the weight is required to be suitably decreased for facilitating the maneuverability of the cycling devices.

For suitably reducing the weight to the cycling devices, some of the typical wheel rims have been made of weight reduced synthetic or fiber materials which may greatly reduce the weight of the cycling devices. For example, U.S. Pat. No. 4,793,659 to Oleff et al. discloses one of the typical wheel rims made of synthetic materials. However, the manufacturing processes are complicated and the cost is greatly increased.

U.S. Pat. No. 4,844,552 to Tsygankov et al. discloses another typical bicycle wheel including two annular diaphragms rigidly coupled to two sides of a rigid rim and a hub. However, similarly, the manufacturing processes are complicated and the cost is greatly increased. In addition, the annular diaphragms are rigidly coupled to two sides of the rigid rim and the hub such that the forces or shocks or vibrations may be directly transmitted from the hub to the rigid rim via the annular diaphragms, and the annular diaphragms may be easily caused to move relative to the rigid rim as a shearing action, and may be easily caused to be separated and disengaged from the rigid rim.

The present invention has arisen to mitigate and/or obviate the afore-described disadvantages of the conventional wheel rims for the typical cycling devices.

### SUMMARY OF THE INVENTION

The primary objective of the present invention is to provide a wheel rim for attaching to various cycling devices, such as unicycles, bicycles, tricycles, cycling exercises, etc., and having an attached inner peripheral member for weight reducing purposes and/or for decorative purposes.

In accordance with one aspect of the invention, there is provided a wheel rim comprising an outer rim member including two side portions each having a serrated surface formed therein and defined by at least one recess and at least one bulge, an inner rim member for attaching to an inner peripheral portion of the outer rim member and including two peripheral flanges for engaging with the side portions of the outer rim member respectively, and an adhesive material applied between the peripheral flanges of the inner rim member and the side portions of the outer rim member for securing the peripheral flanges of the inner rim member to the side portions of the outer rim member.

The inner rim member is preferably made of synthetic materials, and the outer rim member is preferably made of metal or alloy materials. The outer rim member includes a peripheral shoulder formed in each of the side portions thereof for engaging with the peripheral flanges of the inner rim member and for anchoring the peripheral flanges of the inner rim member to the outer rim member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a wheel rim in accordance with the present invention;

FIG. 2 is a partial exploded view of the wheel rim for illustrating an inner structure of the wheel rim;

FIG. 3 is a cross sectional view of the wheel rim taken along lines 3-3 of FIG. 1; and

FIG. 4 is an enlarged partial cross sectional view of the wheel rim.

### DETAILED DESCRIPTION OF THE PREFERRED EMBODIMENT

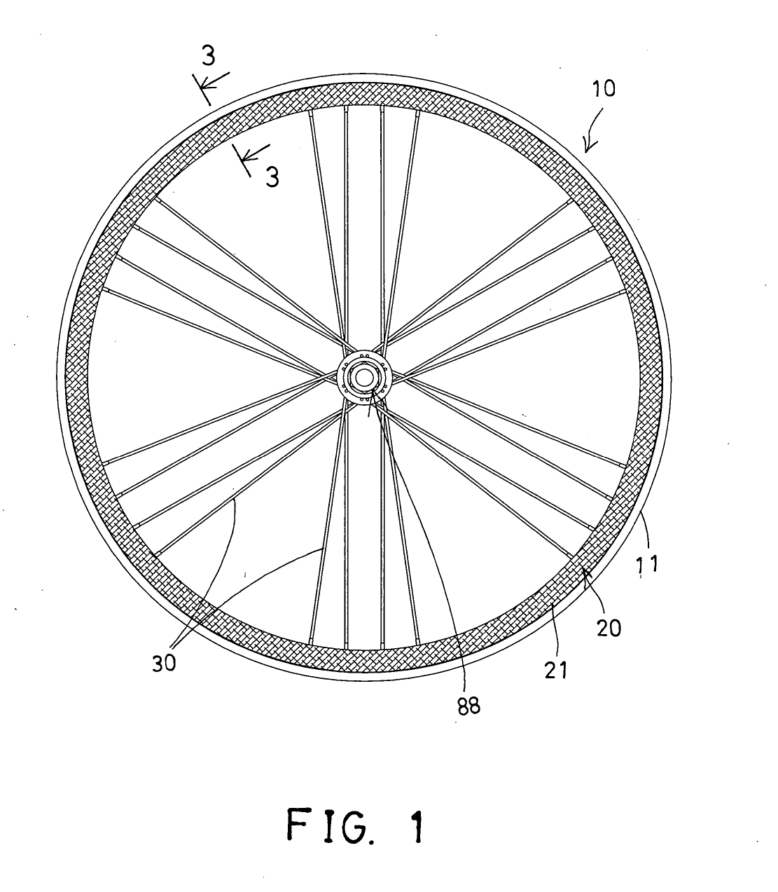

Referring to the drawings, and initially to FIGS. 1-3, a wheel rim 10 in accordance with the present invention comprises a base or outer peripheral rim member 11 including an outer peripheral portion or recess 12 formed or provided therein for receiving or attaching one or more typical rubber tires thereon (not shown), and the outer rim member 11 is preferably made of metal materials selected from such as steel materials, aluminum materials, aluminum alloy materials, molybdenum chrome alloy materials, titanium alloy materials, magnesium alloy materials, or other metal materials, for forming or providing the basic rigidity or strength for the wheel rim 10.

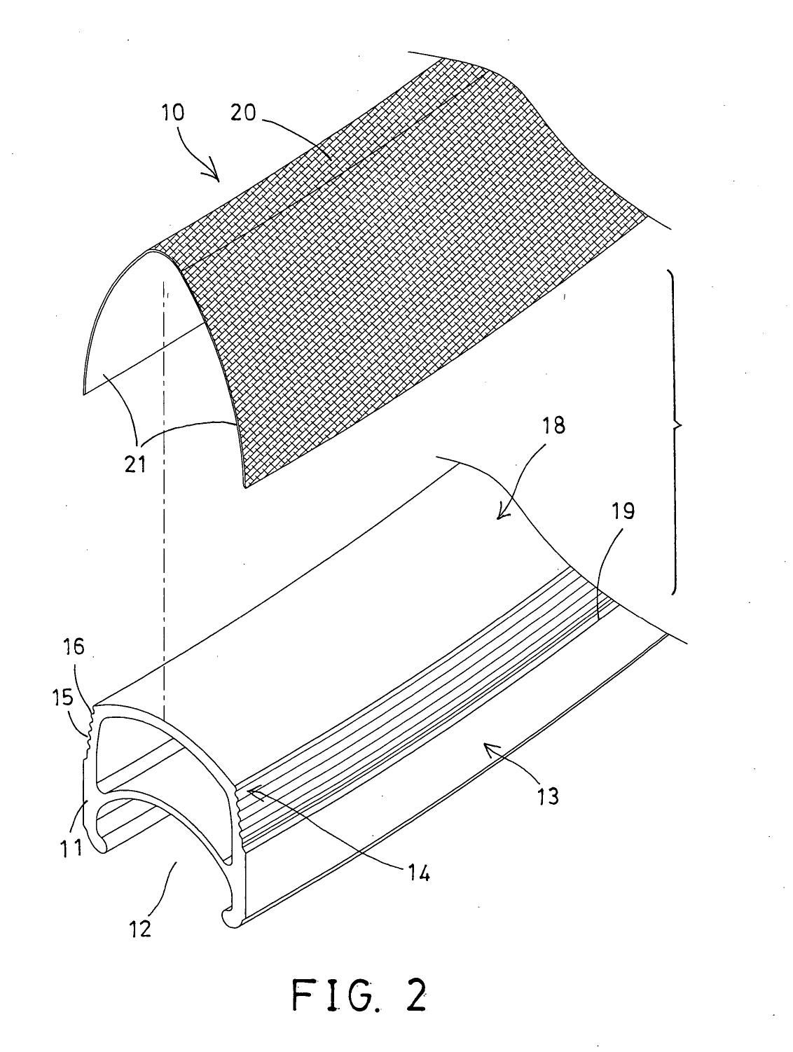

The outer rim member 11 includes two side portions 13 each having a serrated surface 14 formed therein and defined by one or more recesses 15, such as curved peripheral recesses 15, and one or more bulges 16, such as curved peripheral bulges 16 formed or located or arranged alternatively relative to the curved peripheral recesses 15 thereof, best shown in FIGS. 2-4. The wheel rim 10 further includes an inner peripheral rim member 20 attached to an inner peripheral portion 18 of the outer rim member 11 and having a substantially curved or V-shaped or U-shaped cross section and having two outer or peripheral edges or flanges 21 for attaching or engaging or securing onto the two side portions 13 of the outer rim member 11.

The inner peripheral rim member 20 is preferably made of weight reduced synthetic or fiber materials, such as carbon fiber materials, glass fiber materials, etc., and may be easily and quickly manufactured with molding or hot-pressing processes, and may be formed into a smooth outer peripheral surface or configuration for applying various decorative colors and/or patterns thereon and or for decorative purposes. For example, the peripheral flanges 21 of the inner rim member 20 may be attached and secured to the two side portions 13 of the outer rim member 11 with such as cements, or various adhesive materials 80 that are applied between the peripheral flanges 21 of the inner rim member 20 and the side portions 13 of the outer rim member 11.

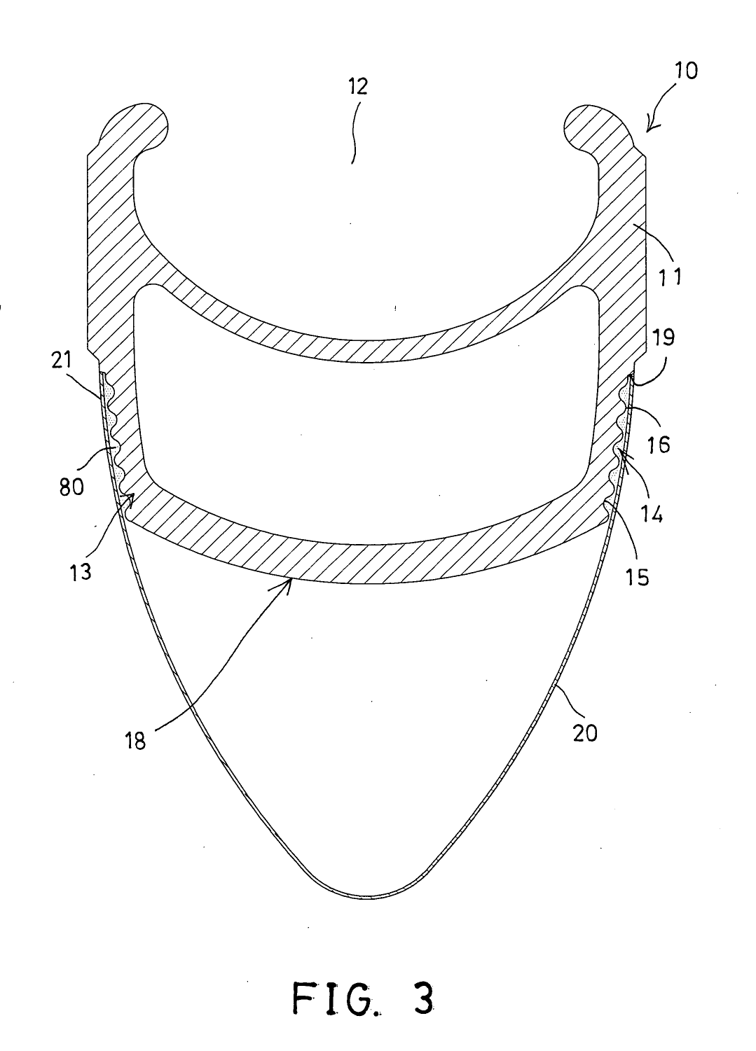

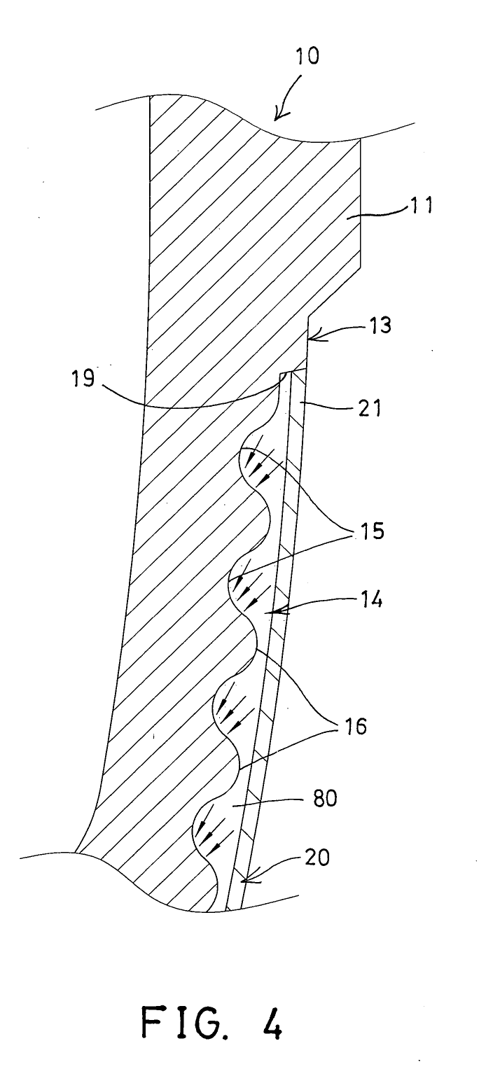

As best shown in FIGS. 3 and 4, the cements or adhesive materials 80 may be suitably received in the curved peripheral recesses 15 of the outer rim member 11 such that the peripheral flanges 21 of the inner rim member 20 may be solidly or suitably secured to the two side portions 13 of the outer rim member 11 with an increased quantity of the adhesive materials 80, and the adhesive materials 80 may have an increased contact area with the side portions 13 of the outer rim member 11. The inner rim member 20 may be used for suitably covering or shielding the end portions of the spokes 30 (FIG. 1), and may suitably decrease the weight of the wheel rim 10 of the cycling devices.

It is to be noted that the inner rim member 20 may be attached to the inner peripheral portion 18 of the wheel rim 10 only, but not attached to the hub 88 of the bicycle wheel (FIG. 1), such that the forces or shocks or vibrations applied to the hub 88 of the bicycle wheel will not be directly transmitted to the inner rim member 20, and such that no shearing force or action may be applied to the inner rim member 20 to force or to cause the inner rim member 20, to be separated and disengaged from the outer rim member 11. It is preferable that the outer rim member 11 includes a peripheral shoulder 19 formed in each of the side portions 13 thereof for engaging with the peripheral flanges 21 of the inner rim member 20 and for suitably anchoring the peripheral flanges 21 of the inner rim member 20 to the outer rim member 11.

Accordingly, the wheel rim in accordance with the present invention may be provided for attaching to various cycling devices, such as unicycles, bicycles, tricycles, cycling exercises, etc., and having the additionally attached inner peripheral member for weight reducing purposes and/or for decorative purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wheel rim comprising:
an outer rim member including two side portions each having a serrated surface formed therein and defined by at least one recess and at least one bulge,
an inner rim member for attaching to an inner peripheral portion of said outer rim member and including two peripheral flanges for engaging with said side portions of said outer rim member respectively, and
an adhesive material applied between said peripheral flanges of said inner rim member and said side portions of said outer rim member for securing said peripheral flanges of said inner rim member to said side portions of said outer rim member.

2. The wheel rim as claimed in claim 1, wherein said outer rim member is made of metal materials.

3. The wheel rim as claimed in claim 1, wherein said inner rim member is made of synthetic materials.

4. The wheel rim as claimed in claim 1, wherein said outer rim member includes a peripheral shoulder formed in each of said side portions thereof for engaging with said peripheral flanges of said inner rim member and for anchoring said peripheral flanges of said inner rim member to said outer rim member.
